(19) United States
(12) Patent Application Publication
(10) Pub. No.: US 2010/0252523 A1
(43) Pub. Date: Oct. 7, 2010

(54) TRANSPORTING APPARATUS FOR TRANSPORTING LOADS TO STORAGE PLACES, IN PARTICULAR IN A HIGH-BAY WAREHOUSE

(76) Inventors: Juergen KRAFT, Guetersloh (DE); Hubert KLEINEWIETFELD, Rietberg (DE); Georg RIEGAS, Bremen (DE)

Correspondence Address: JORDAN AND HAMBURG LLP, 122 EAST 42ND STREET, SUITE 4000, NEW YORK, NY, 10168, US

(21) Appl. No.: 12/691,326

(22) Filed: Jan. 21, 2010

Related U.S. Application Data
(63) Continuation of application No. PCT/EP2008/005615, filed on Jul. 10, 2008.

(30) Foreign Application Priority Data
Jul. 21, 2007 (DE) 10 2007 034 153.0

(51) Int. Cl. B66C 13/06; B65G 1/06

(52) U.S. Cl. 212/273

(57) ABSTRACT

A transporting apparatus for transporting loads to storage places, in particular in a high-bay warehouse, with a crane trolley and with a load-picking-up means which is suspended on the crane trolley, has mechanical damping means for damping pendulum oscillations of the load-picking-up means while the crane trolley is at a standstill.

### BACKGROUND OF THE INVENTION

The invention relates to a transport apparatus for transporting loads to storage places such as those found in a high-bay warehouse.

Such transport apparatus are generally known and are used for placing and retrieving loads, in particular piece goods, such as loaded pallets, into and out of storage places in warehouses.

Known from DE 202 03 604 U1 is a transport apparatus of the aforesaid type for transporting loads to storage places in a high-bay warehouse that have a crane trolley and a load picking means suspended from the crane trolley. In the transport apparatus known from this publication, the load picking means is suspended from cables on the crane trolley, the vertical distance from the load picking means to the crane trolley being adjustable in that the cables are rolled up or down. When loads are being transported, the crane trolley moves in a plane so that it is possible to guide it using a guide system that is attached to a ceiling in a hall of a storage arrangement, such as a high-bay warehouse. In order to place a load into or remove it from a storage place, it is necessary to position the load picking means both vertically and horizontally relative to the storage place where the load is to be placed in storage or removed from storage. The load picking means is positioned horizontally in that the crane trolley is moved appropriately two-dimensionally on its guide arrangement. In contrast, vertical positioning occurs in that the cable from which the load picking means is suspended is rolled up or down so that the load picking means moves vertically.

While the crane trolley is moving, the load picking means leads to undesired pendulum swinging due to its pendular suspension from the cables. Known from DE 201 08 207 U1 (corresponding to DE 101 22 142 A1) is determining the horizontal displacement of the load picking means relative to the crane trolley and, proceeding from the determined displacement, selecting the travel speed and route of the crane trolley such that the undesired pendulum swinging is minimized.

Known from aforementioned DE 202 03 604 U1 is fixing in place the load picking means after reaching a desired position in front of a storage place at a part of the high-bay warehouse so as to avoid undesired movements by the load-picking means relative to the storage place.

The underlying object of the invention is to provide a transport apparatus which operates more efficiently.

### SUMMARY OF THE INVENTION

The invention proceeds from the recognition that it is possible, by means of appropriate control and regulating algorithms, to minimize pendulum swings by the load-picking means relative to the crane trolley while the crane trolley is traveling. This object is aimed at addressing the residual pendulum swings by the load-picking means that occur when the crane trolley is not moving which cause significant time delays during the process of placing loads in storage. This is because the pendulum swings must have subsided nearly entirely before it is possible to begin placing the load in the storage place or removing the load from the storage place. Otherwise the loads may be imprecisely placed in the storage place and there may be malfunctions of or damage to the transport apparatus.

Proceeding from the recognition that the residual pendulum swings cannot be corrected when the crane trolley is not moving, or can only be corrected with great difficulty, the underlying object of the invention is that the process of placing loads in storage can be significantly accelerated in that the residual pendulum swings are damped when the crane trolley is not moving. The invention therefore provides mechanical damping means for damping pendulum swings by the load-picking means when the crane trolley is not moving.

In one inventive transport apparatus, the horizontal displacement of the load-picking means relative to the crane trolley can be determined during travel by the crane trolley, and the travel of the crane trolley with respect to travel routes and speed can be controlled using appropriate control and regulating algorithms such that the pendulum swings that occur during the travel are minimized. After the crane trolley has reached the desired position in front of a storage place, additional adjusting of the pendulum swings using the travel route of the crane trolley is not ordinarily possible because the crane trolley has already stopped moving. In accordance with the invention, pendulum swings that occur when the crane trolley has stopped moving are therefore damped by mechanical damping means. Thus the load-picking means stop moving much more rapidly than in a transport apparatus in accordance with the prior art due to the inventively provided damping means so that it is possible to begin placing a load in the storage place or removing a load from the storage place much more rapidly. In this manner the amount of time required for one transport process is significantly reduced, especially when a plurality of positioning processes for the load-picking means are necessary during one transport process, for instance when one load is picked up at one storage place by means of the transport apparatus and is placed in storage at another storage place, for instance of a high-bay warehouse.

Thus the storage capacity for a storage, arrangement equipped with the inventive transport apparatus is significantly increased.

In accordance with the invention, the inventively provided mechanical damping means can be embodied such that the load picking means are substantially stopped so as to remove the possibility for pendulum swings In accordance with the invention the damping means can also be embodied such that after the inventive damping has occurred the only pendulum swings that occur are so minor that they do not impede placing loads in or removing loads from storage.

The inventive transport apparatus can be employed in any desired storage arrangements. The inventive transport apparatus can be particularly well employed in a high-bay warehouse. The storage arrangement can have an inventive transport apparatus or a plurality of transport apparatuses including at least one the apparatuses described according to the invention.

One refinement of the inventive apparatus provides that the damping means have at least one first part arranged on the load picking means and at least one locationally fixed second part arranged at the storage place that cooperate for damping pendulum swings and that are preferably positioned against one another when the crane trolley is not moving. If the first part and the second part are positioned against one another when the load picking means is not moving, exact positioning of the load picking means relative to the storage place is achieved in this manner. However, it is also inventively possible for the first part and the second part to be arranged at an interval from one another after the pendulum swings have been damped so that there is a certain clearance with respect to the position of the load picking means relative to the storage place as long as this clearance does not impede the load picking means from placing loads into and removing loads from storage.

One extremely advantageous refinement of the inventive apparatus provides that the first part is a positioning part that in a working position is positioned against a locationally fixed stop that is formed at the storage place and that forms the second part. In this embodiment, exact positioning of the load picking means relative to the storage place is achieved when the positioning part is positioned against the stop. During the damping process, residual pendulum swings that occur can lead to the positioning part moving toward the stop in a plurality of successive movements so as to be positioned against the stop, and then moved away from the stop again until the positioning part is preferably positioned against the stop when the pendulum swings have ended.

Another advantageous refinement of the inventive apparatus provides that the positioning part is connected via a retention part to a base body of the load picking means and is movable, relative to the base body, between a rest position and the working position. In this embodiment, the positioning part can be arranged especially inside the delimitations of the load picking means while the crane trolley is traveling so that undesired collisions between the positioning part and a rack arrangement are avoided, and the positioning part is in the working position when the load picking means is not moving, so that in the working position the positioning part projects beyond the delimitations of the load picking means and for instance is positioned against a part of the rack arrangement.

One advantageous refinement of the inventive apparatus provides that the positioning part is pivotable relative to the base body of the load picking means. This embodiment has the advantage that the damping of the pendulum swings can be intensified as the pendulum swings decrease by appropriately selecting the pivot angle of the positioning part.

One refinement of the aforesaid embodiment provides that the retention part is a pivot lever to which a pivot drive is allocated. This embodiment results in a particularly robust and simple construction.

One refinement of the aforesaid embodiment provides that the pivot drive has a piston/cylinder arrangement. Suitable piston/cylinder arrangements for instance in the form of pneumatic or hydraulic cylinders are available as relatively simple, robust, and cost-effective standard components.

Another refinement of the embodiments having the movable positioning part provides that the positioning part can be moved between the working position and the rest position along a linear axis. In accordance with the invention, the positioning part can either perform a pivot movement or a linear movement or a combination of a pivot movement and a linear movement between the working position and the rest position.

One refinement of the aforesaid embodiment provides that the retention part is a slide to which a linear drive is allocated. Suitable linear drives are available for relatively simple, robust, and cost-effective standard components.

In order to attain the greatest possible damping of the pendulum swings, it is advantageous that the stop acts in the pendulum direction of the load picking means.

In accordance with the invention, in the embodiments having the positioning part it is fundamentally sufficient that only one positioning part and one associated stop are provided. To further improve the positioning of the load picking means relative to the rack arrangement, one advantageous refinement of the embodiments having the positioning part comprises at least two positioning parts that are spaced apart in the pendulum direction, one stop of a stop arrangement being allocated to each positioning part.

One extremely advantageous refinement of the aforesaid embodiment provides that while pivoting into the working position the positioning parts clamp the stops in the stop arrangement in a pincer-like manner. In this embodiment, the positioning parts form jaws for a pincer-like arrangement, the inside diameters of the positioning parts being between the stops so that the positioning parts in the working position establish the maximum amplitude of the pendulum swings. In this manner the pendulum swings can be successively damped to zero in that the inside diameter between the stops is reduced successively or by steps.

One particularly advantageous refinement of the aforesaid embodiment provides a control arrangement that can be used to control the drive devices allocated to the retention parts of the positioning parts essentially synchronously with one another such that the positioning parts are essentially pivotable synchronously with one another. In this embodiment the load picking means can be centered relative to the stop arrangement by pivoting the positioning parts synchronously with one another.

Fundamentally, the positioning part can be securely connected to the retention part. In order to promote damping of the pendulum swings, one advantageous refinement of the inventive teaching provides that the positioning part is movably borne on the retention part and is pre-stressed into a null position relative to the retention part by spring means. In this embodiment, if the load picking means swings in a first direction, the positioning part travels until it is positioned against the stop and given another movement by the load picking means so as to move in the first direction against the spring force of the spring means relative to the retention part, the positioning part then being moved back to its null position by the spring means when the load picking means moves in a second direction that opposes the first direction. During this process kinetic energy that the load picking means has during its pendulum swings is converted into heat energy in the spring means. The same effect can also be attained in that the positioning part is securely connected to the retention part, and in particular is embodied integral with the retention part, while the retention part itself is borne movable in the pendulum direction on the base body of the load picking means and is pre-stressed into a null position relative to the base body by the spring means.

Another refinement of the embodiments having the positioning part provides that the positioning part has a rotatably borne roller.

In accordance with another refinement of the inventive teaching, one of the parts is embodied as an essentially conical or cone-shaped centering part that in the working position preferably engages in a centering opening that is formed on the other part. In this manner it is possible to center the centering part in the centering opening so as to attain exact positioning of the load picking means relative to the storage place.

One advantageous refinement of the aforesaid embodiment provides that the centering part at least partly comprises an elastically resilient material, in particular an elastomer. In this embodiment, as well, kinetic energy that the load picking means has due to the pendulum swings is converted to heat energy during the spring process i.e., biasing, for the centering part. One inventive system for storing loads is provided so as, to include at least one inventive transport apparatus as described herein and at least one storage arrangement, in particular at least one high-bay warehouse.

The invention shall be described in greater detail in the following using the attached drawings that depict exemplary embodiments of the inventive transport apparatus. All of the features claimed and described and depicted in the drawings in and of themselves and in any desired combination with one another form the subject-matter of the invention.

### BRIEF DESCRIPTION OF THE DRAWINGS

FIG. 1 is a perspective and elevation view showing the transport apparatus of the invention;

FIG. 2 is a view from above onto the transport apparatus in accordance with FIG. 1;

FIG. 3 is a view from above onto a load picking means of the transport apparatus in accordance with FIG. 2, the load picking means being shown positioned in a rack aisle of a high-bay warehouse.

FIG. 4 shows the functioning of a first exemplary embodiment of machine damping means for damping pendulum swings of the load picking means when the crane trolley is stopped.

FIG. 5 is a perspective and elevation view of a detail from FIG. 3 in the area of the mechanical damping means illustrated in FIG. 4.

FIG. 6 is a view from above onto a second exemplary embodiment of the mechanical damping means.

FIG. 7 is a third exemplary embodiment of the mechanical damping means.

FIG. 8 is a first perspective elevation of a fourth exemplary embodiment of the mechanical damping means.

FIG. 9 is a second perspective and elevation view of the exemplary embodiment in accordance with FIG. 8.

### DETAILED DESCRIPTION OF THE INVENTION

Herein, equivalent components are provided with the same reference numbers in the drawings.

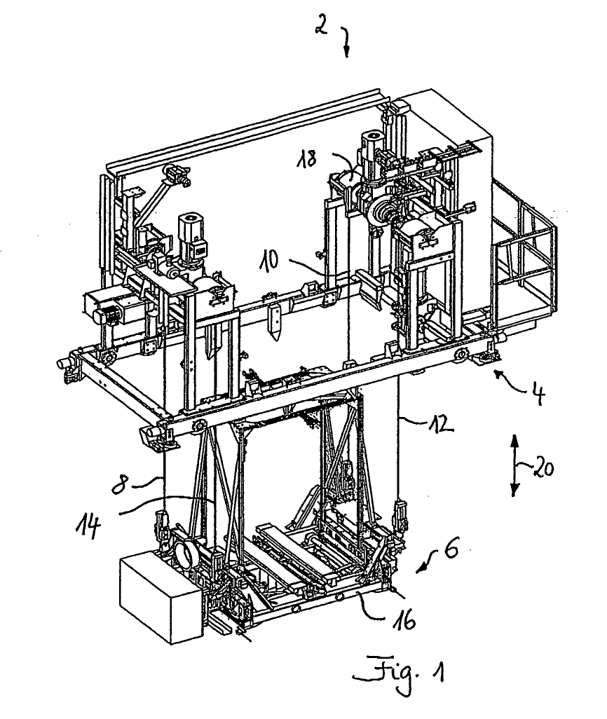

FIG. 1 clarifies the basic structure of one exemplary embodiment of the inventive transport apparatus 2 that transports loads to storage places in a storage arrangement (not shown in FIG. 1). The transport apparatus 2 has a crane trolley 4 that can be moved in a plane in two dimensions on a guide system. The guide system can be attached for instance to the ceiling of a hall in which the storage arrangement is arranged, the storage arrangement in this exemplary embodiment being embodied as a high-bay warehouse. Thus the crane trolley 4 moves in two dimensions beneath the roof of the hall.

A load picking means 6 is suspended from the crane trolley 4 using four cables 8, 10, 12, 14, each of which are attached to suspension points that are arranged at corners of an essentially rectangular base body 16 of the load picking means 6. Allocated to each cable 8 through 14 is a motor-operated winding apparatus, only one of these winding apparatuses being provided with the reference number 18 in FIG. 1. Thus the vertical distance between the load picking means 6 and the crane trolley 4 can be adjusted by synchronously winding the cables 8, 14 by means of the winding apparatus 18, as indicated by a double arrow 20 in FIG. 1.

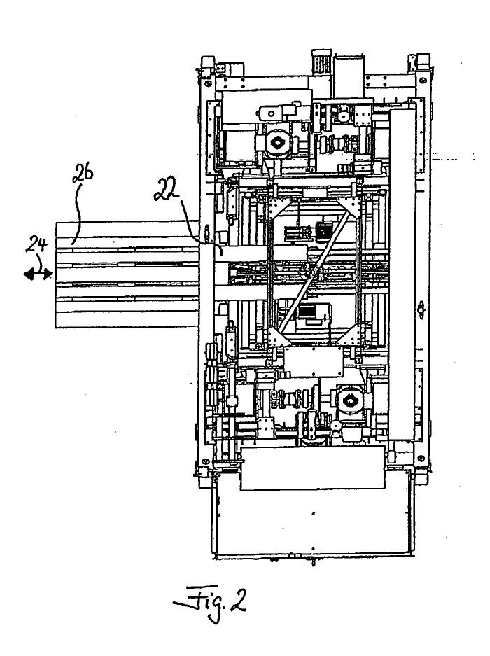

FIG. 2 depicts a view from above onto the transport apparatus 2, and it can be seen that the load picking means 6 in this exemplary embodiment has a fork arrangement 22 that can be moved in and out in the direction of a double arrow 24 in order to place or pick loads, for instance a pallet 24 depicted in FIG. 2, at a storage place or to pick loads at the storage place and move them onto the load picking means 6. The general structure of such a transport apparatus and its individual parts, for instance the crane trolley 4 and the load picking means 6, including the fork arrangement 22, are known in general to one skilled in the art and shall therefore not be explained in greater detail here.

When operating the transport apparatus 2, a pallet 26 is picked up for instance at a transfer place by means of the fork arrangement 22 and moved on the load picking means 6. As soon as the pallet 26 is on the load picking means 6, the load picking means 6 is moved such that it is disposed horizontally and vertically in front of a storage place where the pallet 26 is to be placed in storage. The horizontal positioning is attained by the crane trolley 4 traveling in two dimensions and the vertical positioning is attained by adjusting the distance between the crane trolley 4 and the load picking means 6.

In the context of placing items in and removing items from storage as rapidly as possible, and thus of having the best possible performance for the warehouse, it is desirable for the crane trolley 4 to travel as rapidly as possible and for the distance between the load picking means 6 and the crane trolley 4 to be adjusted as rapidly as possible. Undesired pendulum swings by the load picking means 6 occur relative to the crane trolley 4 during these processes, especially caused by the crane trolley 4 traveling, it being possible to measure the horizontal displacement of the load picking means 6 relative to the crane trolley 4 using a suitable measuring apparatus. The travel routes and travel speed of the crane trolley 4 can then be controlled or regulated based on this measured displacement, that is, the amplitude of the pendulum swing, such that the pendulum swings are minimized.

Often when the load picking means 6 is positioned in front of the storage place provided for storing the items or removing items from storage, additional residual pendulum swings by the load picking means occur when the crane trolley 4 is not moving.

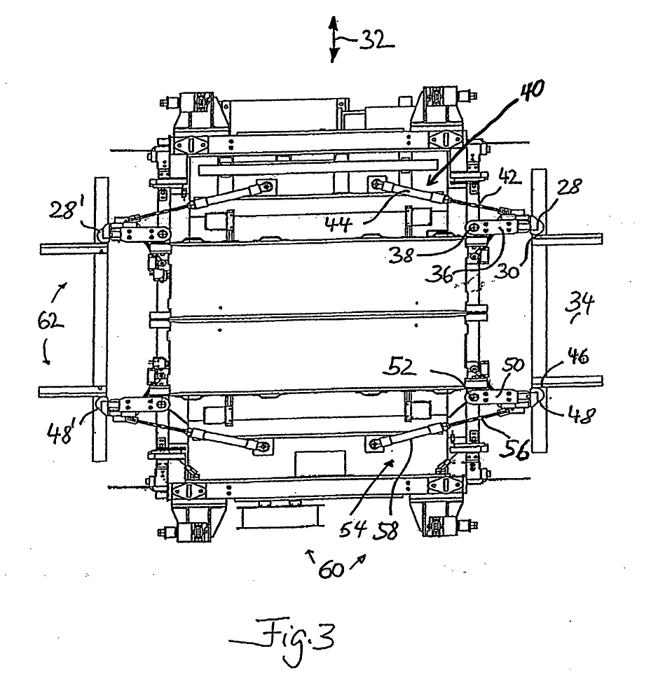

FIG. 3 depicts a view from above onto the load picking means 6 that is provided with a first exemplary embodiment of mechanical damping means for damping pendulum swings by the load picking means 6 when the trolley crane 4 is not moving (residual pendulum swinging). In this exemplary embodiment the damping means have a positioning part formed as a rotatably borne roller 28 that in a working position depicted in FIG. 3 is positioned against a locationally fixed stop 30 formed at the storage place. In FIG. 3, the working position of the positioning part 28 is depicted, in which position the load picking means 6 is not moving, that is, does not have any pendulum swings in the direction of a double arrow 32, and thus is positioned in front of a storage place 34 such that a load can be placed in storage at this storage place 34.

In this exemplary embodiment, the positioning part 28 is connected to the base body 16 of the load picking means 6 via a retention part and is movable relative to the base body between a rest position, which will be explained in greater detail below, and the working position, depicted in FIG. 3. In the exemplary embodiment depicted in FIG. 3, the retention part is formed by a pivot lever 36 by means of which the positioning part 28 can be pivoted about an essentially vertical pivot axis 38 relative to the base body 16. A pivot drive in the form of a piston/cylinder 40 arrangement is allocated to the pivot lever 36, the free end of the piston 42 being hinged to the to the pivot lever 36 and the free end of the cylinder 44 being hinged to the base body 16. The cylinder 44 can be a hydraulic cylinder, for instance.

In the exemplary embodiment depicted in FIG. 3, a stop 30 is part of a stop arrangement that, in addition to the stop 30, has another stop 46 spaced apart in the pendulum direction 32 from the stop 30. Another positioning part 48 connected to the base body 16 in the form of a rotatably borne roller is allocated to the stop 46 so as to cooperate with the stop 46 and can pivot relative to the base body 16 via a pivot lever 50 between the working position depicted in FIG. 3 and a rest position. The pivot lever 50 is pivotably connected to the base body 16 about an essentially vertical pivot axis 52, and a piston/cylinder arrangement 54 is provided as a pivot drive for pivoting the pivot lever 50. The free end of the piston 56 is hinged to the pivot lever 50, while the free end of the cylinder 58 is hinged to the base body 16.

The pivot drives formed by the piston/cylinder arrangements 40 and 54 can be controlled by a common control device in a manner described in greater detail below.

FIG. 3 depicts the load picking means 6 in a rack aisle 60 in which additional storage places are located on the side opposing the storage place 34 whereby one of the additional storage places is shown by reference number 62. As is customary in high-bay warehouses, a plurality of storage places that are arranged above and adjacent to one another are formed on racks that are separated from one another by rack aisles 60.

On its side that faces the storage place 62, the load picking means 6 has another positioning part 28′ as well as another positioning part 48′ that is spaced apart therefrom in the pendulum direction 32, and these are embodied as has been described in the foregoing for the positioning parts 28 and 48. The components allocated to the other positioning parts 28′ and 48′ correspond in their structure and in their function, described in the foregoing and further below in greater detail, to the components allocated to the positioning parts 28, and 48′ are therefore provided with corresponding reference numbers. Only the functioning of the positioning parts 28, 48 shall be described in greater detail in the following. The positioning parts 28′, 48′ function in the same manner and this will therefore not be described in greater detail.

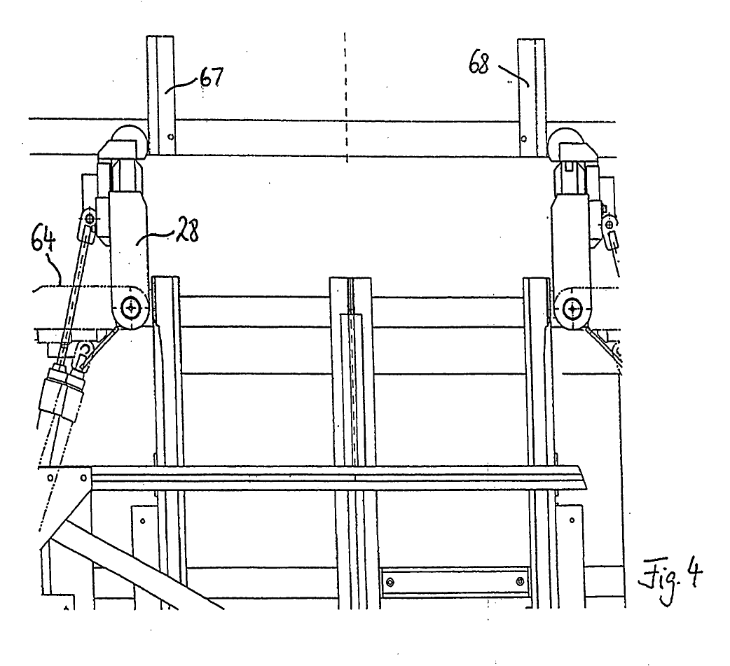

FIG. 4 is a sketch of the principle for clarifying the functioning of the positioning parts 28, 48, the manner of function of the positioning part 28 being described in greater detail in the following. The manner of functioning of the positioning part 48 is the same and will therefore not be explained in greater detail.

In a rest position, indicated by the broken line 64 in FIG. 4, the positioning part 28 is disposed within the delimitations of the load picking means 6. When the crane trolley 4 is traveling, that is, while the load picking means is being positioned relative to the storage arrangement, the positioning means 28 is in the rest position 64 depicted in FIG. 4 so that a collision with the parts of the storage arrangement is avoided.

The crane trolley 4 stops moving once the load picking means 6 has reached the desired position relative to the storage place 34 in that the crane trolley 4 has traveled appropriately and the vertical distance between the crane trolley 4 and the load picking means has been adjusted appropriately. When the crane trolley 4 is not moving, the load picking means 6 continues to experience residual pendulum swings in the direction of the double arrow 32 that, although small in amplitude, are nevertheless large enough to prevent secure pick-up or placement of pallets by means of the fork arrangement 22.

In order to damp these pendulum swings, the positioning parts 28, 48 are pivoted by means of the allocated piston/cylinder arrangement 40 and 54 such that they clamp the stops 30, 46 of the stop arrangement in a pincer-like manner, as depicted in FIG. 4. The pistons/cylinder arrangements 40, 54 are controlled synchronously using a common control device such that the positioning parts 28, 48 pivot synchronously with one another. Here there is especially the possibility of successively reducing the inside diameter, i.e., the distance, between the two positioning parts 28, 48 in the pendulum direction so that the amplitude of the pendulum swings is successively reduced to zero.

The control device can in particular be embodied such that the positioning parts 28′, 48′ can also pivot synchronously with the positioning parts 28, 48 (see FIG. 3).

Once the positioning parts 28, 48 have been pivoted such that they are positioned against the respective stops 30, 46 with no clearance or essentially no clearance, the load picking means 6 is at rest and is centered in front of the storage place 34. In this position a load can be put into or taken out of storage at the storage place 34 by means of the fork arrangement 22.

The stops 30, 46 can be formed using separate components. In the exemplary embodiment depicted in FIG. 4, they are formed by the outer surfaces of profiles 67, 68 that run in the longitudinal direction of the storage place 34.

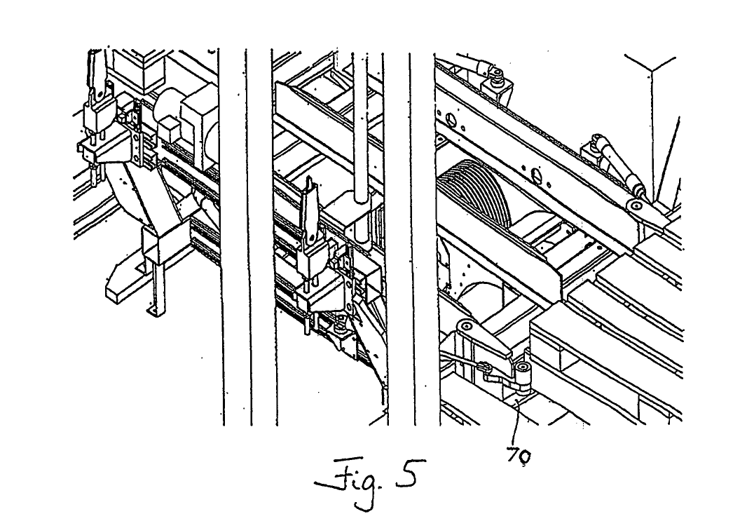

FIG. 5 is a perspective and elevation view of the load picking means in the rest position, and it is evident that the positioning part 48 is positioned against the stop 46. Once the residual pendulum swings have been completely damped, that is, when the load picking means 6 is not moving, the load picking means 6 can be lowered vertically somewhat so that the axial end face of the positioning part 28 is supported on a transverse support 66 for the storage place 34. The same applies for the other positioning parts 28, 28′, and 48′.

Since the residual pendulum swings by the load picking means 6 have been damped and the load picking means are positioned precisely in front of the storage place 34, it is possible to begin placing the articles in storage or removing them from storage much earlier than when the residual pendulum swings are not damped in the manner enabled by the present invention. In this manner the storage capacity of a high-bay warehouse equipped with an exemplary embodiment of the inventive transport apparatus 2 is increased substantially.

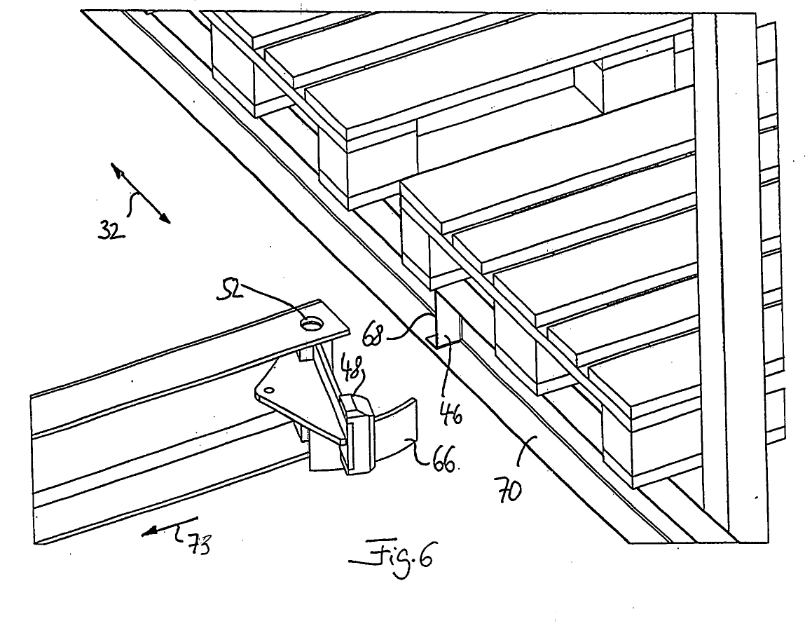

FIG. 6 depicts a detail from a second exemplary embodiment of an inventive transport apparatus 2 in the area of the positioning part 48 that is distinguished from the exemplary embodiment in accordance with FIGS. 1-5 primarily in that the positioning part 48 is provided with a tab 66, the radius of which curves continuously about the pivot axis 52. The stop 46 is formed on a stop element in the form of a C profile 68 that is connected to a transverse support 70 provided on the storage place 34.

In the working position in which the positioning part 48 is positioned against the stop 46, the tab 66 engages the C profile 68 so that the load picking means in this embodiment is fixed to a certain degree not only in the pendulum direction 32 but also in a direction perpendicular thereto, symbolized by an arrow 73 in FIG. 6. In contrast, in the exemplary embodiment in accordance with FIGS. 1-5, the load picking means 6 is fixed only in the pendulum direction 32 according to FIGS. 1-5, and is nevertheless fundamentally able to move in the direction of the arrow 72 and in an opposing direction.

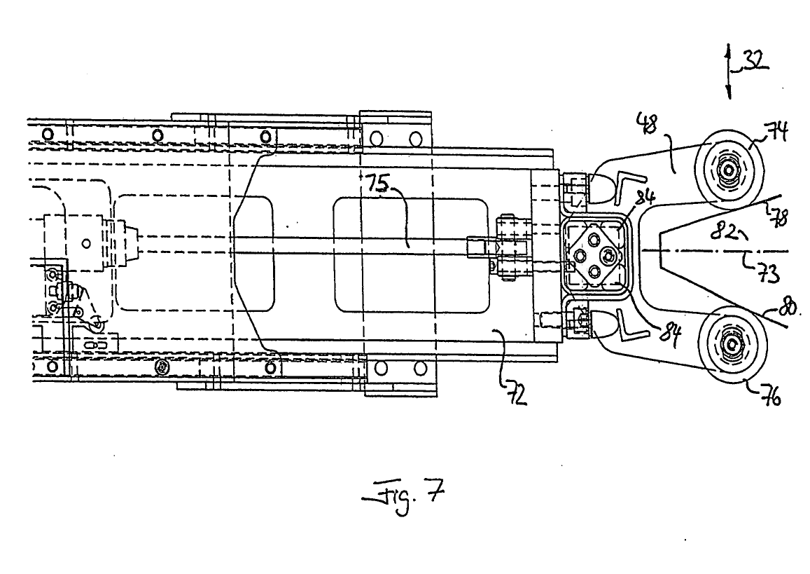

FIG. 7 depicts a detail of a third exemplary embodiment of an inventive transport apparatus in the area of the positioning part 48. The exemplary embodiment in accordance with FIG. 7 is first of all distinguished from the exemplary embodiment in accordance with FIGS. 1-5 in that the positioning part 48 is linearly movable along a linear movement axis that is represented symbolically by a dot-dash line 73 and that is between the working position depicted in FIG. 7 and the rest position. A retention part for retaining the positioning part 48 is formed by a slide 72 that can be re-positioned along the linear movement axis 73 by means of a piston/cylinder arrangement, of which only the piston 75 is identifiable in FIG. 7. In this exemplary embodiment, the positioning part 48 is embodied in a fork shape and at its free ends has rotatably borne rollers 74, 76 that are positioned against respective stop surfaces 78, 80 of a wedge-shaped stop element 82 on the storage place 34 in the working position depicted in FIG. 7.

The positioning part 48 is pivotably connected to the slide 72 about an essentially vertical pivot axis. As is evident from FIG. 7, in this exemplary embodiment the positioning part 48 is borne movable in the pendulum direction on the slide 72, which forms the retention part. Furthermore, the positioning part 48 is pre-stressed in a null position relative to the retention part 72, this position being illustrated in FIG. 7, by using spring means that in this exemplary embodiment is formed by rubber buffers 84 arranged between the slide 72 and the positioning part 48.

For damping residual pendulum swings, in the exemplary embodiment depicted in FIG. 7 the positioning means 48 are displaced to the right by means of the slide 72 in FIG. 7 so that during the residual pendulum swings the rollers 74, 76 are initially alternately positioned against the respective stop surfaces 78, 80, the positioning part 48 pivoting about its pivot axis relative to the slide 72 against the spring effect of the rubber buffers 84. The rubber buffers 84 restore the positioning part 48 to the null position depicted in FIG. 7, the kinetic energy that the load picking means 6 has due to its residual pendulum swings being converted to heat energy when the rubber buffers 86 are compressed. As the slide 72 is further displaced to the right in FIG. 7, the amplitude of the residual pendulum swings decreases' until the rollers 74, 76 are positioned with essentially no clearance against the stop surfaces 78, 80 in the working position as depicted in FIG. 7. In this working position, the load picking means 6 is positioned relative to the storage place 34 and the positioning part 48 is centered with respect to the stop part 82.

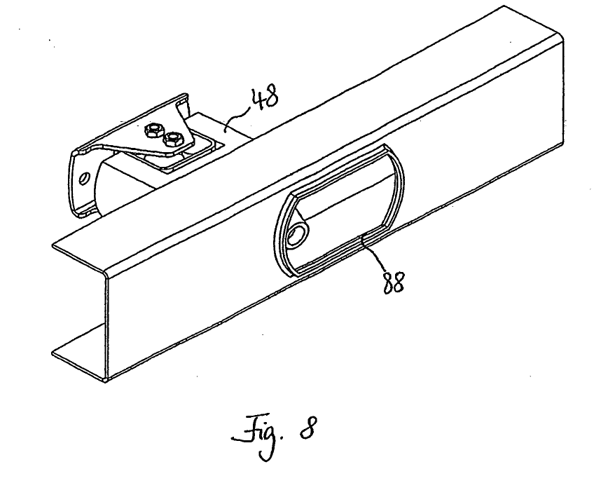

FIG. 8 depicts a detail of a fourth exemplary embodiment of an inventive transport apparatus in the area of the positioning part 48. This exemplary embodiment is distinguished from the exemplary embodiment in accordance with FIGS. 1 through 5 in that the positioning part 48 is embodied as an essentially conical centering part that in the working position engages in a centering opening 88 formed on the storage place 34. Relative to the retention part, which has been omitted from FIG. 8 for reasons of clarity, the positioning part 48 can be pivoted about an essentially vertical pivot axis and pre-stressed using spring means (not shown in FIG. 8) into the null position shown in FIG. 8.

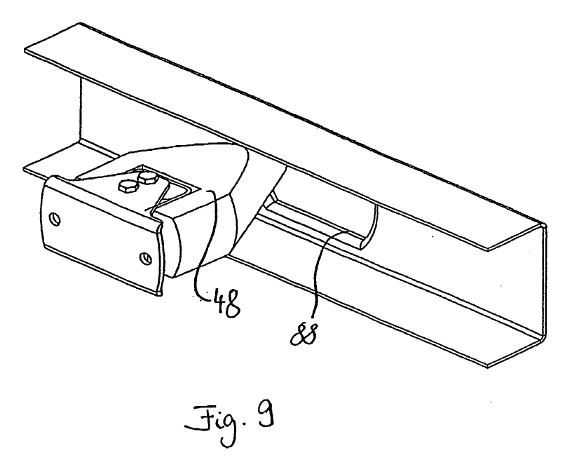

FIG. 9 provides a different perspective elevation of the positioning part 48 in accordance with the third exemplary embodiment.

For damping residual pendulum swings, in this exemplary embodiment the positioning part 48 in FIG. 9 is displaced to the right so that it engages in the centering opening 88. As the displacement increases, during the residual pendulum swings the lateral sides of the positioning part 48 are positioned at the edges of the centering opening 88 the positioning part 48 pivoting relative to its retention part. In the working position, both lateral surfaces of the positioning part 48 are positioned with essentially no clearance against opposing edges of the centering opening 88 so that in this working position the load picking means 6 is positioned with no clearance in the pendulum direction 32 relative to the storage place 34.

In the exemplary embodiments in accordance with FIG. 6 and FIG. 7 and FIG. 8 and FIG. 9, appropriate additional positioning parts can be provided to the positioning part 48 as was described for the additional positioning parts 28, 28′, and 48′ depicted in FIG. 3 for the exemplary embodiment in accordance with FIG. 1.

1. A transport apparatus for transporting loads to storage places, comprising:
a crane trolley; and
a load picking means suspended on the crane trolley; and
damping means for damping pendulum swings by the load picking means in a pendulum direction while the crane trolley is not moving.

2. The transport apparatus in accordance with claim 1, wherein the damping means comprises at least one first part arranged on the load picking means and at least one locationally fixed second part arranged at the storage place that cooperate for damping pendulum swings and that are positioned against one another when the load picking means is not moving.

3. The transport apparatus in accordance with claim 2, wherein the first part is a positioning part that in a working position is positioned against a locationally fixed stop that is formed at the storage place and that forms the second part.

4. The transport apparatus in accordance with claim 3, wherein the positioning part is connected via a retention part to a base body of the load picking means and is movable, relative to the base body, between a rest position and the working position.

5. The transport apparatus in accordance with claim 4, wherein the positioning part is pivotable relative to the base body of the load picking means.

6. The transport apparatus in accordance with claim 5, wherein the retention part is a pivot lever to which a pivot drive is allocated.

7. The transport apparatus in accordance with claim 6, that wherein the pivot drive has a piston and cylinder arrangement.

8. The transport apparatus in accordance with claim 7, wherein the positioning part can be moved linearly between the working position and the rest position along a linear axis.

9. The transport apparatus in accordance with claim 8, wherein the retention part is a slide to which a linear drive is allocated.

10. The transport apparatus in accordance with claim 9, wherein the stop acts in the pendulum direction of the load picking means.

11. The transport apparatus in accordance with any of claims 3 through 10, further comprising a second positioning part being pivotable relative to the base body of the load picking means and spaced apart in the pendulum direction from the first positioning part, and a second stop is allocated to the second positioning part.

12. The transport apparatus in accordance with claim 11, wherein while pivoting into the working position the positioning parts clamp the stops (30, 46) in a pincer-like manner.

13. The transport apparatus in accordance with claim 12, further comprising a control arrangement that can be used to control the drive devices allocated to the retention parts of the positioning parts synchronously with one another so that the positioning parts are pivotable synchronously with one another.

14. The transport apparatus in accordance with claim 4, wherein the positioning part is borne moveable in the pendulum direction on the retention part and is pre-stressed into a null position relative to the retention part by spring means.

15. The transport apparatus in accordance with claim 14, wherein the positioning part has at least one rotatably borne roller.

16. The transport apparatus in accordance with claim 2, wherein one of the parts is configured as an essentially conical or cone-shaped centering part that in the working position adaptably engages in a centering opening formed on the other part.

17. The transport apparatus in accordance with claim 16, wherein the centering part at least partly comprises an elastically resilient material comprising an elastomer.

18. A system for storing loads comprising the transport apparatus of claim 1 or 2.
